(19) United States
(12) Patent Application Publication
(10) Pub. No.: US 2005/0289610 A1
(43) Pub. Date: Dec. 29, 2005

(54) Television broadcast receiving system and television broadcast receiver

(75) Inventors: Toshihiro Takagi, Osaka (JP); Yoshihisa Nagamura, Osaka (JP); Yasuhiro Inui, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/167,275

(22) Filed: Jun. 28, 2005

(30) Foreign Application Priority Data
Jun. 28, 2004 (JP) 2004-189973

(51) Int. Cl. H04N 7/20; H04N 5/50

(52) U.S. Cl. 725/72; 348/570

(57) ABSTRACT

A television receiver is connected to a smart antenna, and comprises: a tuner for receiving, and measuring signal intensity of, a television signal; an OSD superimposer for superimposing, on the television signal, an image indicating an active receiving direction of the antenna; and a microprocessor for outputting, to the antenna and respective elements of the television receiver, various signals including a receiving direction control signal. Based on the signal intensity, the microprocessor determines the active receiving direction of the antenna, and outputs a receiving direction control signal to the antenna, and further outputs a signal indicating the active receiving direction of the antenna to the OSD superimposer which is connected to a monitor for image display. The antenna comprises: a control unit for making active one receiving direction commanded by the receiving direction control signal; and a display for displaying the commanded receiving direction. A user can easily recognize the receiving direction of the antenna, either at the television receiver site or the antenna site.

### BACKGROUND OF THE INVENTION

1. Field of the Invention

The present invention relates to a television broadcast receiving system and a television broadcast receiver for receiving a terrestrial broadcast transmitted from multiple directions.

2. Description of the Related Art

In the North American Continent where ATSC (Advanced Television Systems Committee) digital television is broadcast, big cities spread across the plains. Accordingly, digital television broadcast signals, which are broadcast in big cities or their suburbs, can be received in other cities or intermediate areas between the cities. In addition, the conventional NTSC (National Television System Committee) analog television continues to be broadcast. From the viewpoint of each television user or viewer, television broadcast signals come from various directions. Thus, it is necessary for the television user to adjust the direction of an antenna in the direction of a broadcast tower transmitting a television broadcast signal of a television program which the user wishes to watch.

For this reason, multi-directional antennas such as a so-called smart antenna are put to practical use. The EIA (Electronic Industries Association)-909 standard provides a smart antenna having sixteen equiangular receiving directions in 360 degrees. Some of multi-directional antennas which are actually commercialized are handy type such that the number of receiving directions is only 4 or 8. Furthermore, there are various types of multi-directional antennas such as one that changes the receiving direction by rotating the antenna using a motor, and one that has multiple antennas and selects an active antenna direction by turning on and off electronic switches (the antenna themselves do not rotate).

On the other hand, some of television broadcast receivers each connected to such multi-directional antenna are each set to be able to adjust the receiving direction of the multi-directional antenna. They have an automatic omni-directional scanning function to automatically select the receiving direction of the multi-directional antenna in which a television broadcast signal of a channel selected by a television user can be best received.

Meanwhile, Japanese Laid-open Patent Publication Hei 9-284196 discloses a satellite receiving antenna system designed for the convenience of installing a satellite receiving antenna such as a phased array antenna. The satellite receiving antenna system has a display on a receiving antenna for displaying a satellite desired to be received and a level of the receiving antenna. Furthermore, Japanese Laid-open Patent Publication Hei 8-163553 discloses a satellite receiving antenna having an indicator for notifying a user that the antenna is pointed at the satellite desired to be received.

However, the case of terrestrial television broadcast is in contrast to the case of satellite television broadcast using a satellite receiving antenna described in each of the two Japanese Patent Publications. In the case of satellite television broadcast, a geostationary satellite is used for transmitting television broadcast signals, and a receiving antenna is pointed at the geostationary satellite. On the other hand, in the case of terrestrial television broadcast, broadcast towers are used to transmit television broadcast signals by terrestrial waves. Accordingly, due to obstacles of high rise buildings and influence of multipath, a best receiving direction of an antenna may not always coincide with a direction of a broadcast tower. Thus, in the case of terrestrial television broadcast in contrast to satellite broadcast, it may not always be possible to allow a user to recognize an accurate receiving direction of an antenna by merely displaying the direction of radio wave transmission (direction of a broadcast tower in the case of terrestrial television broadcast) on e.g. the antenna.

In countries like the United States of America, cable television is widespread, and indoor antennas are often used to receive terrestrial broadcasts. However, the indoor antennas usually cannot receive terrestrial broadcasts in good conditions, and may vary in the receiving conditions such as signal intensities of television broadcast signals due to e.g. just human movement in a room. In such case, conventional television broadcast receiving systems do not make it possible for a user to accurately understand the reason for the variation of receiving conditions, and to properly adjust the installation environment of the antenna.

### SUMMARY OF THE INVENTION

An object of the present invention is to provide a television broadcast receiver and a television broadcast receiving system that can allow a user to easily recognize the receiving direction and signal intensity of a television broadcast signal received by a multi-directional antenna, whether the user is located at the site of the television broadcast receiver or the site of the multi-directional antenna.

According to a first aspect of the present invention, we provide a television broadcast receiving system including a multi-directional antenna to be used in predetermined multiple receiving directions and a television broadcast receiver connected to the multi-directional antenna for receiving a television broadcast signal by making one of the multiple receiving directions active.

The television broadcast receiver comprises: a tuner connected to the multi-directional antenna for receiving a television broadcast signal and measuring signal intensity of the received television broadcast signal; an on-screen display (hereafter referred to simply as “OSD”) signal superimposer for superimposing, on the television broadcast signal received by the tuner, a signal of an image indicating an active receiving direction of the multi-directional antenna; and a microprocessor for outputting, to the multi-directional antenna and respective elements of the television broadcast receiver including the OSD signal superimposer, various signals including a receiving direction control signal for commanding the multi-directional antenna as to the receiving direction of the television broadcast signal.

Based on a value of the signal intensity of the television broadcast signal measured by the tuner, the microprocessor determines the active receiving direction of the multi-directional antenna, and outputs, to the multi-directional antenna, a receiving direction control signal for commanding the active receiving direction, and further outputs, to the OSD signal superimposer, a signal indicating the active receiving direction of the multi-directional antenna. Further, based on the signal indicating the active receiving direction of the multi-directional antenna, the OSD signal superimposer superimposes a signal of an image indicating the active receiving direction of the multi-directional antenna on the television broadcast signal so as to produce a combined image signal, and outputs the combined image signal to a monitor connected to the television broadcast receiver.

The multi-directional antenna of the television broadcast receiving system comprises: a control unit for making active one of the multiple receiving directions which is commanded by the receiving direction control signal from the television broadcast receiver; and a display for displaying the receiving direction commanded by the receiving direction control signal from the television broadcast receiver.

According to the television broadcast receiving system of the first aspect of the present invention as described above, based on the signal indicating the active receiving direction of the multi-directional antenna, the signal of an image indicating the active receiving direction of the multi-directional antenna is superimposed on the television broadcast signal so as to produce a combined image signal which is then output to a monitor connected to the television broadcast receiver. Accordingly, at the site of the television broadcast receiver, a user can easily recognize the receiving direction of the multi-directional antenna for receiving the television broadcast signal. In addition, the display of the multi-directional antenna displays the receiving direction commanded by the receiving direction control signal from the television broadcast receiver. Accordingly, the user can easily recognize the receiving direction of the multi-directional antenna at the site of the multi-directional antenna as well.

Preferably, the microprocessor of the television broadcast receiver outputs, to the multi-directional antenna and the OSD signal superimposer, a signal indicating a value of the signal intensity of the television broadcast signal measured by the tuner, wherein based on the signal indicating the value of the signal intensity of the television broadcast signal, the OSD signal superimposer superimposes, on the television broadcast signal, a signal of an image indicating the signal intensity of the television broadcast signal so as to produce a further combined image signal, and outputs the further combined image signal to the monitor, and wherein the display of the multi-directional antenna displays the signal intensity of the television broadcast signal based on the signal indicating the value of the signal intensity.

This makes it possible for the user to easily and more readily recognize the signal intensity of the television broadcast signal received by the multi-directional antenna, at either the site of the television broadcast receiver or the site of the multi-directional antenna.

It is possible to design that the display of the multi-directional antenna is formed of multiple light emitting diodes placed at positions corresponding to the multiple receiving directions, respectively, and that the control unit of the multi-directional antenna lights one of the light emitting diodes which is placed at a position corresponding to the receiving direction commanded by the receiving direction control signal from the television broadcast receiver.

Preferably, based on the signal indicating the value of the signal intensity of the television broadcast signal from the television broadcast receiver, the control unit of the multi-directional antenna adjusts lighting state of the light emitting diode placed at the position corresponding to the receiving direction commanded by the receiving direction control signal.

According to a second aspect of the present invention, we provide a television broadcast receiving system including a multi-directional antenna to be used in predetermined multiple receiving directions and a television broadcast receiver connected to the multi-directional antenna for receiving a television broadcast signal by making one of the multiple receiving directions active.

The television broadcast receiver comprises: a receiving means connected to the multi-directional antenna for receiving a television broadcast signal and measuring signal intensity of the received television broadcast signal; an image superimposing means for superimposing, on the television broadcast signal received by the receiving means, a signal of an image indicating an active receiving direction of the multi-directional antenna; and a control means for outputting, to the multi-directional antenna and respective elements of the television broadcast receiver including the image superimposing means, various signals including a receiving direction control signal for commanding the multi-directional antenna as to the receiving direction of the television broadcast signal.

Based on a value of the signal intensity of the television broadcast signal measured by the receiving means, the control means determines the active receiving direction of the multi-directional antenna, and outputs, to the multi-directional antenna, a receiving direction control signal for commanding the active receiving direction, and further outputs, to the image superimposing means, a signal indicating the active receiving direction of the multi-directional antenna. Further, based on the signal indicating the active receiving direction of the multi-directional antenna, the image superimposing means superimposes a signal of an image indicating the active receiving direction of the multi-directional antenna on the television broadcast signal so as to produce a combined image signal, and outputs the combined image signal to a monitor connected to the television broadcast receiver.

The multi-directional antenna comprises: a receiving direction switching means for making active one of the multiple receiving directions which is commanded by the receiving direction control signal from the television broadcast receiver; and a display means for displaying the receiving direction commanded by the receiving direction control signal from the television broadcast receiver.

According to a third aspect of the present invention, we provide a television broadcast receiver to be connected to a multi-directional antenna having predetermined multiple receiving directions for receiving a television broadcast signal by making one of the multiple receiving directions active, the television broadcast receiver comprising: a tuner connected to the multi-directional antenna for receiving a television broadcast signal and measuring signal intensity of the received television broadcast signal; an on-screen display (hereafter referred to simply as “OSD”) signal superimposer for superimposing, on the television broadcast signal received by the tuner, a signal of an image indicating an active receiving direction of the multi-directional antenna; and a microprocessor for outputting, to the multi-directional antenna and respective elements of the television broadcast receiver including the OSD signal superimposer, various signals including a receiving direction control signal for commanding the multi-directional antenna as to the receiving direction of the television broadcast signal.

Based on a value of the signal intensity of the television broadcast signal measured by the tuner, the microprocessor determines the active receiving direction of the multi-directional antenna, and outputs, to the multi-directional antenna, a receiving direction control signal for commanding the active receiving direction, and further outputs, to the OSD signal superimposer, a signal indicating the active receiving direction of the multi-directional antenna. Further, based on the signal indicating the active receiving direction of the multi-directional antenna, the OSD signal superimposer superimposes a signal of an image indicating the active receiving direction of the multi-directional antenna on the television broadcast signal so as to produce a combined image signal, and outputs the combined image signal to a monitor connected to the television broadcast receiver.

According to a fourth aspect of the present invention, we provide a television broadcast receiver to be connected to a multi-directional antenna having predetermined multiple receiving directions for receiving a television broadcast signal by making one of the multiple receiving directions active, the television broadcast receiver comprising: a receiving means connected to the multi-directional antenna for receiving a television broadcast signal and measuring signal intensity of the received television broadcast signal; an image superimposing means for superimposing, on the television broadcast signal received by the receiving means, a signal of an image indicating an active receiving direction of the multi-directional antenna; and a control means for outputting, to the multi-directional antenna and respective elements of the television broadcast receiver including the image superimposing means, various signals including a receiving direction control signal for commanding the multi-directional antenna as to the receiving direction of the television broadcast signal.

Based on a value of the signal intensity of the television broadcast signal measured by the receiving means, the control means determines the active receiving direction of the multi-directional antenna, and outputs, to the multi-directional antenna, a receiving direction control signal for commanding the active receiving direction, and further outputs, to the image superimposing means, a signal indicating the active receiving direction of the multi-directional antenna. Further, based on the signal indicating the active receiving direction of the multi-directional antenna, the image superimposing means superimposes a signal of an image indicating the active receiving direction of the multi-directional antenna on the television broadcast signal so as to produce a combined image signal, and outputs the combined image signal to a monitor connected to the television broadcast receiver.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a conceptual view showing a situation in which a TV (television) broadcast receiving system according to an embodiment of the present invention installed in a general home receives TV broadcast signals;

FIG. 2 is a schematic block diagram of the TV broadcast receiving system according to the embodiment of the present invention;

FIG. 3 is a schematic top plan view of a smart antenna in the TV broadcast receiving system;

FIG. 4 is a flow chart showing an oni-directional scan process performed by a TV broadcast receiver of the TV broadcast receiving system;

FIG. 5 is a flow chart showing a receiving condition output process of outputting information about the receiving direction of the smart antenna and information about the signal intensity of the TV broadcast signal; and

FIG. 6A is a schematic view showing an example of a screen for the receiving condition output process, while FIG. 6B is a schematic top plan view of the smart antenna in the receiving condition output process.

### DESCRIPTION OF THE PREFERRED EMBODIMENTS

The best modes and preferred embodiments of the present invention will be described hereinafter with reference to the annexed drawings. Note that the specific embodiments described are not intended to cover the entire scope of the present invention, and hence the present invention is not limited to only the specific embodiments.

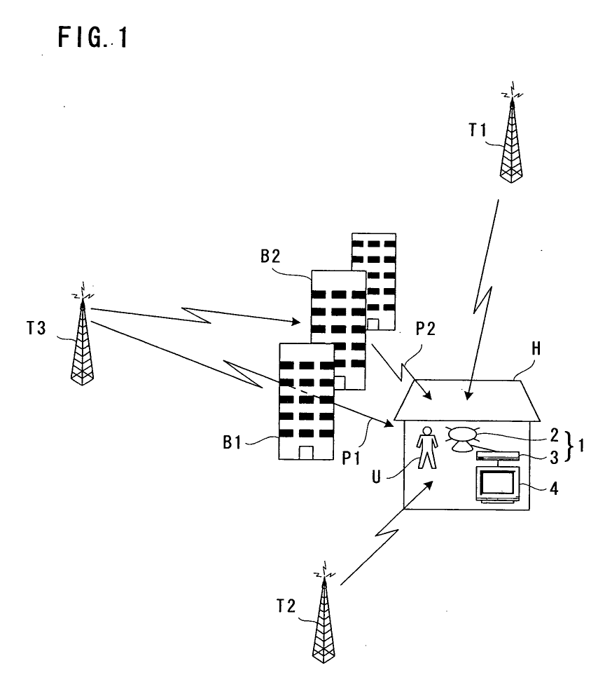

FIG. 1 is a conceptual view showing a situation in which a TV (television) broadcast receiving system according to an embodiment of the present invention installed in a general home receives TV broadcast signals from three broadcast towers. As shown in FIG. 1, the TV broadcast receiving system 1 according to the present embodiment comprises a smart antenna 2, which have multiple receiving directions, and a TV broadcast receiver 3 connected to the smart antenna 2. The TV broadcast receiver 3 is connected to a monitor 4 for displaying images of TV programs and outputting sounds.

Under the control of the TV broadcast receiver 3, the TV broadcast receiving system 1 switches an active receiving direction of the smart antenna 2 (namely, makes one of the multiple receiving directions of the smart antenna 2 active) so as to receive a digital TV broadcast signal (hereafter referred to simply as “TV broadcast signal”) transmitted in a given frequency band from each of broadcast towers T1, T2 and T3 spreading across multiple locations, and to output a TV program contained in the TV broadcast signal in each channel to the monitor 4.

Based on the signal intensities, i.e. values of the signal intensities, of a TV broadcast signal of each channel in the respective receiving directions of the smart antenna 2, the TV broadcast receiving system 1 determines a best receiving direction for receiving the TV broadcast signal of each channel. For example, the TV broadcast receiving system 1 performs a later described omni-directional scan process so as to determine the receiving direction to give a highest signal intensity of the received TV broadcast signal of each channel as a direction of best receiving condition of the each channel. Thus, for TV broadcast signals of channels transmitted from the broadcast towers T1 and T2, the directions of the broadcast towers T1 and T2 are usually the best receiving directions of the TV broadcast signals of the respective channels.

However, if high rise constructions such as high rise buildings B1 and B2 exist near the smart antenna between the broadcast tower T3 and a house H as shown in FIG. 1, a radio wave PI transmitted from the broadcast tower T3 may be obstructed e.g. by the high rise building B1, while a radio wave P2 which is the same as the radio wave P1 from the broadcast tower T3 may be reflected by the high rise building B2. In this case, the radio wave P2 reflected from the high rise building B2 may have a higher signal intensity than that of the radio wave P1 transmitted directly from the broadcast tower T3, the direction of which would primarily give the best receiving state or condition if there were not the radio wave P2. On the other hand, in the case where the smart antenna 2 is installed inside the house H, the receiving condition of receiving the TV broadcast signal may vary due to movement of a user U in a room of the house H. In such case, the TV broadcast receiving system 1 of the present embodiment is advantageous because it can allow the user U to recognize easily at a glance the control state of the smart antenna 2 and the receiving condition of the television broadcast signal as will be described hereinafter.

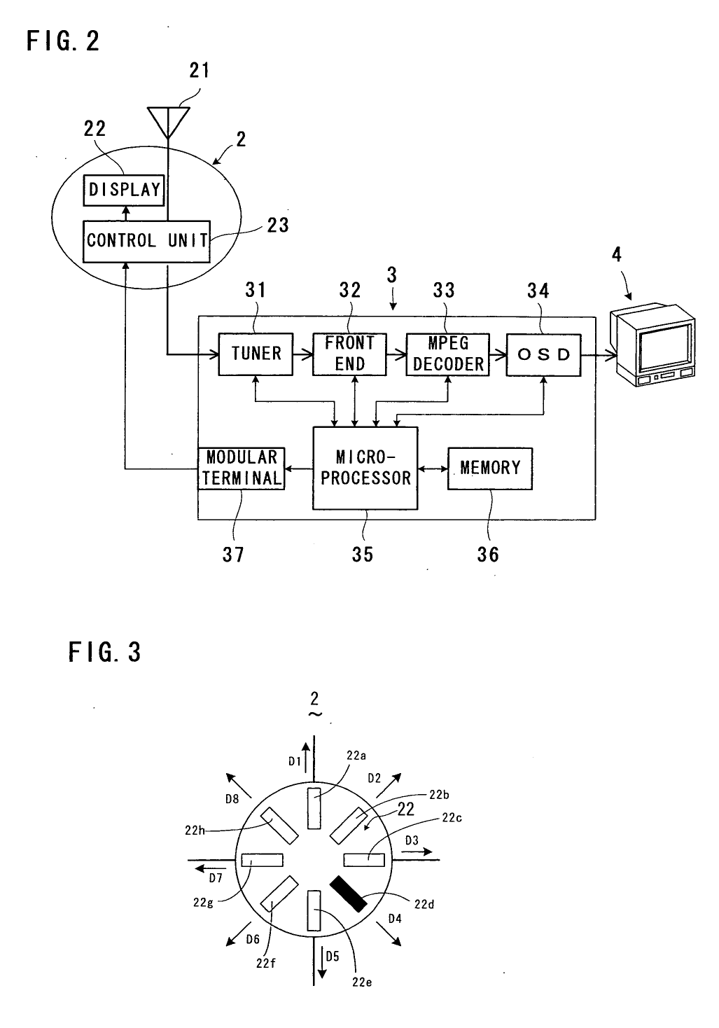

Now, the smart antenna 2 and the TV broadcast receiver 3 forming the TV broadcast receiving system 1 according to the present embodiment will be described with reference to FIG. 2 which shows a schematic block diagram of the TV broadcast receiving system 1, and to FIG. 3 which shows a schematic top plan view of the smart antenna 2. The smart antenna 2 comprises: an antenna unit 21 for receiving TV broadcast signals from multiple (eight) receiving directions D11 to D8 as provided in the EIA (Electronic Industries Association)-909 standard by mechanically or electronically switching an active receiving direction (namely, making one of the multiple receiving directions active); a display 22 (claimed “display means”) having multiple (eight) light emitting diodes (hereafter referred to simply as “LED” or “LEDs”) 22a to 22h placed corresponding to the multiple receiving directions D1 to D8 of the antenna unit 21 for displaying each receiving direction (which is commanded by the receiving direction control signal from the TV broadcast receiver 3 as will be described below); and a control unit 23 for controlling the operation of each of the antenna unit 21 and the LEDs 22a to 22h.

The control unit 23 serves as a claimed “receiving direction switching means” which, in response to a receiving direction control signal from the TV broadcast receiver 3, makes active one of the receiving directions D1 to D8 which is commanded by the receiving direction control signal. The control unit 23 further lights one of the LEDs 22a to 22h placed at a position corresponding to the active receiving direction in order to notify the user of information of the active receiving direction of the smart antenna 2. The control unit 23 also adjusts or varies the lighting state of each of the LEDs 22a to 22h in lighting the LED according to the signal intensity of the received TV broadcast signal in order to notify the user of information of the signal intensity.

Referring to FIG. 2, the TV broadcast receiver 3 comprises: a tuner (receiving means) 31 connected to the smart antenna 2 for receiving a TV broadcast signal and measuring the signal intensity of the received TV broadcast signal; a front end 32 for subjecting the TV broadcast signal received by the tuner 31 to predetermined signal processing, and decoding the received TV broadcast signal; an MPEG (Motion Picture Experts Group) decoder 33 for decoding the TV broadcast signal which is an MPEG-compressed signal; an on-screen display (hereafter referred to simply as “OSD”) signal superimposer (image superimposing means) 34 for superimposing a signal of a predetermined display image on the decoded TV broadcast signal; a microprocessor (control means) 35 for detecting receiving conditions of TV broadcast signals received by the tuner 31 so as to control the control unit 23 of the smart antenna 2, and for controlling the entire TV broadcast receiver 3; a memory 36 for storing a best receiving direction for the TV broadcast signal of each receivable channel; a modular terminal 37; and so on.

The TV broadcast signal decoded by the MPEG decoder 33 is output to the monitor 4 via the OSD signal superimposer 34 for display. For a later described receiving condition output process, the OSD signal superimposer 34 superimposes, on the TV broadcast signal, a signal of an image indicating an active receiving direction of the smart antenna 2 and a signal intensity of the received TV broadcast signal. The microprocessor 35 outputs various signals, including a receiving direction control signal for commanding the smart antenna 2 as to the receiving direction of a TV broadcast signal, to the smart antenna 2 as well as to respective elements or units of the TV broadcast receiver 3 including the OSD signal superimposer 34.

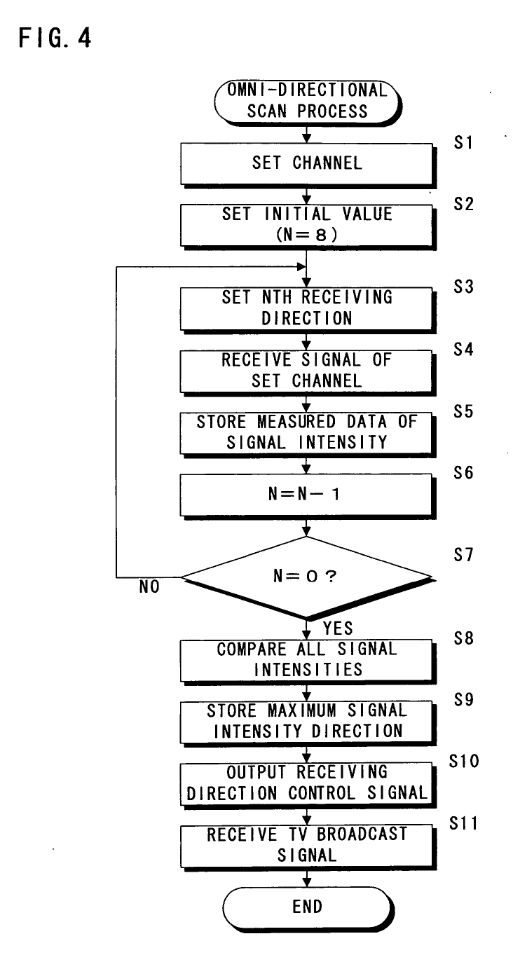

Hereinafter, referring to the flow chart of FIG. 4, an omni-directional scan process performed by the TV broadcast receiver 3 for determining a best receiving direction for each receivable channel will be described.

When a user selects an omni-directional scan mode, and sets a channel to view (SI), the microprocessor 35 sets an initial value n (here n=8) of a counter according to the number of the receiving directions D1 to D8 of the smart antenna 2 (S2). The microprocessor 35 outputs, to the smart antenna 2, a control signal to command an nth receiving direction (S3), so that the tuner 31 receives a TV broadcast signal of the set channel (S4).

The TV broadcast receiver 3 further measures the signal intensity of the received TV broadcast signal, and stores the measured data of signal intensity in the memory 36 (S5). Thereafter, the TV broadcast receiver 3 decrements the counter by one (S6), and determines whether or not the TV broadcast receiver 3 has measured signal intensities of the received TV broadcast signal for all the receiving directions of the smart antenna 2 (S7). If the TV broadcast receiver 1 has not measured signal intensities of the TV broadcast signal for all the receiving directions (NO in S7), the TV broadcast receiver 1 goes back to the step S3, and measures the signal intensity or intensities of the TV broadcast signal not having been measured (more specifically measures the signal intensity of the TV broadcast signal for each subsequent receiving channel until completion).

If the TV broadcast receiver 1 completes the measurements of the signal intensities of the TV broadcast signal for all the receiving directions (YES in S7), so that the TV broadcast receiver 1 stores all the measured data of signal intensities in the memory 36, the microprocessor 35 reads the measured data stored in the memory 36. The microprocessor 35 then compares all the signal intensities (S8), and thereby determines the receiving direction to give the maximum signal intensity (hereafter referred to as “maximum signal intensity direction”), and further stores the maximum signal intensity direction for the channel in the memory 36 (S9). The microprocessor 35 outputs, to the control unit 23 of the smart antenna 2, a receiving direction control signal for commanding the receiving direction (claimed “active receiving direction of multi-directional antenna”) corresponding to the maximum signal intensity direction (S10), and the tuner 31 starts receiving a TV broadcast signal of the set channel (S11). Note that in order to perform the omni-directional scan process for all the receivable channels (such scan being hereafter referred to as “all-channel scan”), the omni-directional scan for one channel described here is to be repeated for each of the channels.

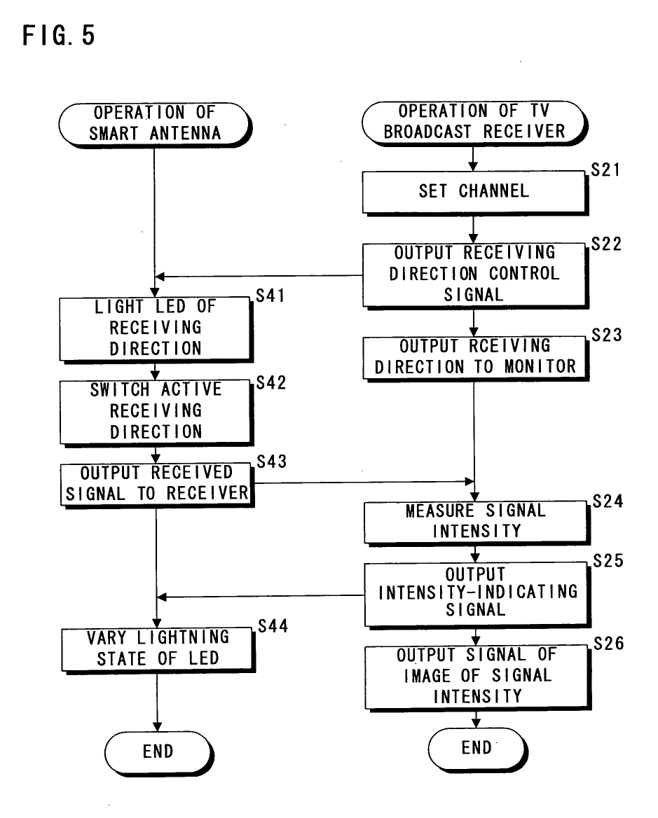

Next, referring to the flow chart of FIG. 5, the following describes a receiving condition output process of outputting, to the OSD signal superimposer 34 and the smart antenna 2, information about the active receiving direction (maximum signal intensity direction) of the smart antenna 2 and information about the signal intensity of the TV broadcast signal. When a user selects a receiving condition output mode, and sets a channel to view (S21), the microprocessor 35 reads the maximum signal intensity direction of the channel from the memory 36, and performs control for the TV broadcast receiver 3 to output, to the smart antenna 2, a receiving direction control signal to command a receiving direction corresponding to the maximum signal intensity direction (S22). The TV broadcast receiver 3 then outputs, to the monitor 4, information about the receiving direction of the channel to be selected here (namely, maximum signal intensity direction) (S23).

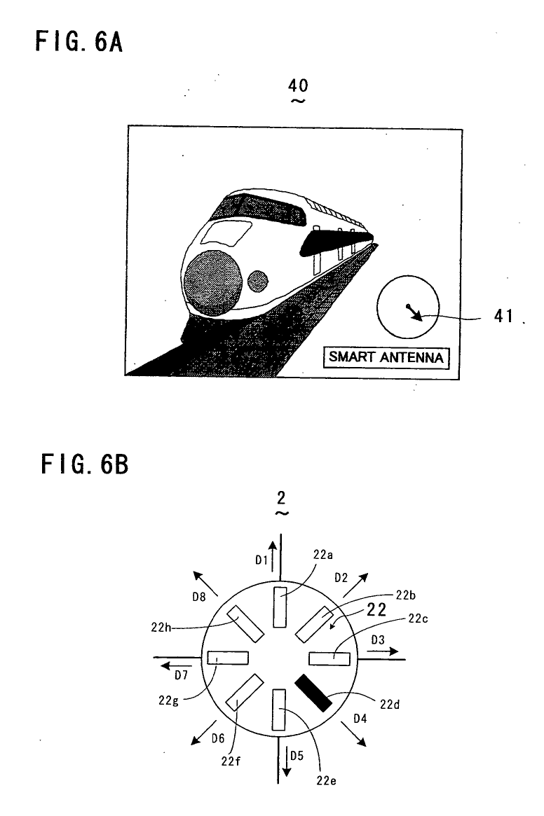

This will be described below in more detail with reference to FIG. 6A which shows an example of a screen for the receiving condition output process, and to FIG. 6B which shows a top plan view of the smart antenna in the receiving condition output process in addition to FIG. 5. Based on the receiving direction control signal, the OSD signal superimposer 34 superimposes, on the television broadcast signal, a signal of an image indicating an active receiving direction of the smart antenna 2 so as to produce a combined image signal, and outputs the combined image signal to the monitor 4. The microprocessor 35 performs control for the monitor 4 to display, for example, an arrow (image of arrow) 41 on a screen of the monitor 4 as shown in FIG. 6A so as to notify, by the direction of the arrow 41, the user of the receiving direction of the channel to be selected. Thus, according to the present embodiment, the arrow 41 is an image indicating an active receiving direction of the smart antenna 2, while a signal of the arrow image, such as a signal corresponding to the direction of the arrow 41, is a signal of an image indicating the active receiving direction of the smart antenna 2. The microprocessor 35 also performs control for the monitor 4 to e.g. blink the arrow 41 so as to notify the user that the TV broadcast receiver 3 is in the process of channel selection.

On the other hand, the smart antenna 2 having received the receiving direction control signal lights or blinks an LED 22d placed at a position corresponding to the receiving direction commanded by the receiving direction control signal out of the LEDs 22a to 22h placed at positions corresponding to the receiving directions D1 to D8 as shown in FIG. 6B, respectively, so as to notify the user of the receiving direction of the channel to be selected (S41). Based on the receiving direction control signal, the smart antenna 2 switches the active receiving direction (S42), and outputs a received TV broadcast signal to the TV broadcast receiver 3 (S43).

The tuner 31 of the TV broadcast receiver 3 demodulates the TV broadcast signal received via the smart antenna 2, and outputs the received TV broadcast signal to the front end 32, and further measures the signal intensity of the received TV broadcast signal (S24). Based on the signal intensity of the received TV broadcast signal measured by the tuner 31, the microprocessor 35 generates an intensity-indicating signal in a given format indicating the signal intensity, i.e. a value of the signal intensity, of the received TV broadcast signal. The microprocessor 35 outputs the intensity-indicating signal to the smart antenna 2 via the modular terminal 37 (S25), and also outputs the intensity-indicating signal to the OSD signal superimposer 34. Based on the intensity-indicating signal, the OSD signal superimposer 34 outputs, to the monitor 4, the arrow 41 which is designed to vary in length so that the length becomes shorter as the signal intensity of the received TV broadcast signal becomes stronger or higher (S26). Thus, according to the present embodiment, the arrow 41 is an image indicating signal intensity of the received TV broadcast signal, while a signal of the arrow image, such as a signal corresponding to the length of the arrow 41, is a signal of the image indicating the signal intensity of the received TV broadcast signal (that is the intensity-indicating signal).

On the other hand, based on the received intensity-indicating signal, the control unit 23 of the smart antenna 2 varies or adjusts the lighting state of the LED 22d so as to notify the user of information about the signal intensity of the received TV broadcast signal (S44). An example of a method for varying the lighting state of the LED 22d is to vary lighting time or light amount of the LED 22d in proportion to the signal intensity.

The foregoing has described a receiving condition output process in the case where a user sets a channel to view. However, the receiving condition output process can be similarly applied to the case of the omni-directional scan process, the all-channel scan process, and the like. By similarly applying the above described receiving condition output process to e.g. the omni-directional scan process and the all-channel scan process, it is possible for the TV broadcast receiver 3 to output a receiving direction control signal and an intensity-indicating signal to the smart antenna 2 in the case of e.g. the omni-directional scan process and the all-channel scan process as well. Thus, not only at the site of the TV broadcast receiver 3, but also at the site of the smart antenna 2, it is possible to notify the user of the signal intensity of a received TV broadcast signal and the receiving direction of the smart antenna 2 (control state of the smart antenna 2), in which the smart antenna 2 receives the TV broadcast signal, in the case of e.g. the omni-directional scan process and the all-channel scan process as well.

Furthermore, according to the above embodiments, the arrow 41 is used both as an image indicating an active receiving direction of the smart antenna 2 and as an image indicating signal intensity of the received TV broadcast signal. More specifically, the direction of the arrow 41 is used as the former image, while the length of the arrow 41 is used as the latter image. However, it is evident that separate different images can be used as the former image and the latter image, respectively.

As described in the foregoing, according to the TV broadcast receiving system 1 of the present embodiment, the TV broadcast receiver 3 outputs, to not only the monitor 4 of the TV broadcast receiver 3 but also the smart antenna 2, information about the active receiving direction of the smart antenna 2 and information about the signal intensity of a TV broadcast signal. Accordingly, the TV broadcast system 1 can allow a user to easily recognize the control state (receiving direction) of the smart antenna 2 and signal intensity of a television broadcast signal received by the smart antenna 2, whether the user is located at the site of the television broadcast receiver 3 or the site of the smart antenna 2.

In particular, the information about the active receiving direction of the smart antenna 2 and the information about the signal intensity of the TV broadcast signal are output in a form visually easily recognizable, using the direction and length of the arrow 41 on the TV broadcast receiver 3, and using the LED 22d on the smart antenna 2. Accordingly, a user can recognize at a glance the receiving direction of the TV broadcast signal of the smart antenna 2 and the signal intensity of the TV broadcast signal. Thus, e.g. in the case where the smart antenna 2 is installed in a room, and when the receiving condition of the smart antenna 2 such as the signal intensity of the television broadcast signal received by the smart antenna 2 varies due to human movement in the room, the user can easily and accurately understand the reason for the variation of the receiving condition, and can easily and properly adjust the installation environment of the smart antenna 2.

It is to be noted that the present invention is not limited to the above embodiments, and various modifications are possible. For example, the above embodiments have described the case of receiving digital television broadcast signals. However, the present invention can be similarly applied to the case of receiving analog television broadcast signals. By performing a similar process or processes in the case of the analog television broadcast signals as in the case of the digital television broadcast signals, it is possible for the television broadcast receiving system 1 or the television broadcast receiver 3 to output, to the TV broadcast receiver 3 and the smart antenna 2, the information about the active receiving direction of the smart antenna 2 and the information about the signal intensity of the TV broadcast signal. In addition, the smart antenna 2 is not necessarily installed indoors. It is evident from the above descriptions that even in the case where the smart antenna 2 is installed outdoors, it is possible according to the present invention to similarly notify a user of receiving conditions, such as receiving direction, of the smart antenna 2.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2004-189973 filed Jun. 28, 2004, the contents of which are hereby incorporated by reference.

1. A television broadcast receiving system including a multi-directional antenna to be used in predetermined multiple receiving directions and a television broadcast receiver connected to the multi-directional antenna for receiving a television broadcast signal by making one of the multiple receiving directions active,
the television broadcast receiver comprising:
a tuner connected to the multi-directional antenna for receiving a television broadcast signal and measuring signal intensity of the received television broadcast signal;
an on-screen display (hereafter referred to simply as “OSD”) signal superimposer for superimposing, on the television broadcast signal received by the tuner, a signal of an image indicating an active receiving direction of the multi-directional antenna; and
a microprocessor for outputting, to the multi-directional antenna and respective elements of the television broadcast receiver including the OSD signal superimposer, various signals including a receiving direction control signal for commanding the multi-directional antenna as to the receiving direction of the television broadcast signal,
wherein based on a value of the signal intensity of the television broadcast signal measured by the tuner, the microprocessor determines the active receiving direction of the multi-directional antenna, and outputs, to the multi-directional antenna, a receiving direction control signal for commanding the active receiving direction, and further outputs, to the OSD signal superimposer, a signal indicating the active receiving direction of the multi-directional antenna, and
wherein based on the signal indicating the active receiving direction of the multi-directional antenna, the OSD signal superimposer superimposes a signal of an image indicating the active receiving direction of the multi-directional antenna on the television broadcast signal so as to produce a combined image signal, and outputs the combined image signal to a monitor connected to the television broadcast receiver, and
the multi-directional antenna comprising:
a control unit for making active one of the multiple receiving directions which is commanded by the receiving direction control signal from the television broadcast receiver; and
a display for displaying the receiving direction commanded by the receiving direction control signal from the television broadcast receiver.

2. The television broadcast receiving system according to claim 1,
wherein the microprocessor of the television broadcast receiver outputs, to the multi-directional antenna and the OSD signal superimposer, a signal indicating a value of the signal intensity of the television broadcast signal measured by the tuner,
wherein based on the signal indicating the value of the signal intensity of the television broadcast signal, the OSD signal superimposer superimposes, on the television broadcast signal, a signal of an image indicating the signal intensity of the television broadcast signal so as to produce a further combined image signal, and outputs the further combined image signal to the monitor, and
wherein the display of the multi-directional antenna displays the signal intensity of the television broadcast signal based on the signal indicating the value of the signal intensity.

3. The television broadcast receiving system according to claim 2,
wherein the display of the multi-directional antenna is formed of multiple light emitting diodes placed at positions corresponding to the multiple receiving directions, respectively, and
wherein the control unit of the multi-directional antenna lights one of the light emitting diodes which is placed at a position corresponding to the receiving direction commanded by the receiving direction control signal from the television broadcast receiver.

4. The television broadcast receiving system according to claim 3,
wherein based on the signal indicating the value of the signal intensity of the television broadcast signal from the television broadcast receiver, the control unit of the multi-directional antenna adjusts lighting state of the light emitting diode placed at the position corresponding to the receiving direction commanded by the receiving direction control signal.

5. The television broadcast receiving system according to claim 1,
wherein the display of the multi-directional antenna is formed of multiple light emitting diodes placed at positions corresponding to the multiple receiving directions, respectively, and
wherein the control unit of the multi-directional antenna lights one of the light emitting diodes which is placed at a position corresponding to the receiving direction commanded by the receiving direction control signal from the television broadcast receiver.

6. A television broadcast receiving system including a multi-directional antenna to be used in predetermined multiple receiving directions and a television broadcast receiver connected to the multi-directional antenna for receiving a television broadcast signal by making one of the multiple receiving directions active,
the television broadcast receiver comprising:
a receiving means connected to the multi-directional antenna for receiving a television broadcast signal and measuring signal intensity of the received television broadcast signal;
an image superimposing means for superimposing, on the television broadcast signal received by the receiving means, a signal of an image indicating an active receiving direction of the multi-directional antenna; and
a control means for outputting, to the multi-directional antenna and respective elements of the television broadcast receiver including the image superimposing means, various signals including a receiving direction control signal for commanding the multi-directional antenna as to the receiving direction of the television broadcast signal,
wherein based on a value of the signal intensity of the television broadcast signal measured by the receiving means, the control means determines the active receiving direction of the multi-directional antenna, and outputs, to the multi-directional antenna, a receiving direction control signal for commanding the active receiving direction, and further outputs, to the image superimposing means, a signal indicating the active receiving direction of the multi-directional antenna, and
wherein based on the signal indicating the active receiving direction of the multi-directional antenna, the image superimposing means superimposes a signal of an image indicating the active receiving direction of the multi-directional antenna on the television broadcast signal so as to produce a combined image signal, and outputs the combined image signal to a monitor connected to the television broadcast receiver, and
the multi-directional antenna comprising:
a receiving direction switching means for making active one of the multiple receiving directions which is commanded by the receiving direction control signal from the television broadcast receiver; and
a display means for displaying the receiving direction commanded by the receiving direction control signal from the television broadcast receiver.

7. A television broadcast receiver to be connected to a multi-directional antenna having predetermined multiple receiving directions for receiving a television broadcast signal by making one of the multiple receiving directions active, the television broadcast receiver comprising:
a tuner connected to the multi-directional antenna for receiving a television broadcast signal and measuring signal intensity of the received television broadcast signal;
an on-screen display (hereafter referred to simply as “OSD”) signal superimposer for superimposing, on the television broadcast signal received by the tuner, a signal of an image indicating an active receiving direction of the multi-directional antenna; and
a microprocessor for outputting, to the multi-directional antenna and respective elements of the television broadcast receiver including the OSD signal superimposer, various signals including a receiving direction control signal for commanding the multi-directional antenna as to the receiving direction of receiving the television broadcast signal,
wherein based on a value of the signal intensity of the television broadcast signal measured by the tuner, the microprocessor determines the active receiving direction of the multi-directional antenna, and outputs, to the multi-directional antenna, a receiving direction control signal for commanding the active receiving direction, and further outputs, to the OSD signal superimposer, a signal indicating the active receiving direction of the multi-directional antenna, and
wherein based on the signal indicating the active receiving direction of the multi-directional antenna, the OSD signal superimposer superimposes a signal of an image indicating the active receiving direction of the multi-directional antenna on the television broadcast signal so as to produce a combined image signal, and outputs the combined image signal to a monitor connected to the television broadcast receiver.

8. The television broadcast receiver according to claim 7,
wherein the microprocessor outputs, to the multi-directional antenna and the OSD signal superimposer, a signal indicating a value of the signal intensity of the television broadcast signal measured by the tuner, and
wherein based on the signal indicating the value of the signal intensity of the television broadcast signal, the OSD signal superimposer superimposes, on the television broadcast signal, a signal of an image indicating the signal intensity of the television broadcast signal so as to produce a further combined image signal, and outputs the further combined image signal to the monitor.

9. A television broadcast receiver to be connected to a multi-directional antenna having predetermined multiple receiving directions for receiving a television broadcast signal by making one of the multiple receiving directions active, the television broadcast receiver comprising:
a receiving means connected to the multi-directional antenna for receiving a television broadcast signal and measuring signal intensity of the received television broadcast signal;
an image superimposing means for superimposing, on the television broadcast signal received by the receiving means, a signal of an image indicating an active receiving direction of the multi-directional antenna; and
a control means for outputting, to the multi-directional antenna and respective elements of the television broadcast receiver including the image superimposing means, various signals including a receiving direction control signal for commanding the multi-directional antenna as to the receiving direction of the television broadcast signal,
wherein based on a value of the signal intensity of the television broadcast signal measured by the receiving means, the control means determines the active receiving direction of the multi-directional antenna, and outputs, to the multi-directional antenna, a receiving direction control signal for commanding the active receiving direction, and further outputs, to the image superimposing means, a signal indicating the active receiving direction of the multi-directional antenna, and
wherein based on the signal indicating the active receiving direction of the multi-directional antenna, the image superimposing means superimposes a signal of an image indicating the active receiving direction of the multi-directional antenna on the television broadcast signal so as to produce a combined image signal, and outputs the combined image signal to a monitor connected to the television broadcast receiver.
